(19) United States
(12) Patent Application Publication
(10) Pub. No.: US 2020/0410358 A1
(43) Pub. Date: Dec. 31, 2020

(54) EFFICIENT ARTIFICIAL INTELLIGENCE ACCELERATOR

(71) Applicant: Vathys, Inc., Portland, OR (US)

(72) Inventor: Tapabrata Ghosh, Portland, OR (US)

(21) Appl. No.: 16/457,512

(22) Filed: Jun. 28, 2019

(51) Int. Cl. G06N 3/08; G06F 7/58; G06F 7/499

(52) U.S. Cl. CPC G06N 3/084; G06F 7/57; G06F 7/49947; G06F 7/58

(57) ABSTRACT

Artificial intelligence workloads can take advantage of low-precision hardware to reduce their hardware overhead compared to high-precision systems. Stochastic rounding is used to enable low bit-width operations. Disclosed are systems and methods for artificial intelligence accelerators that provide efficient rounding for low bit-width operations and other processing tasks by reusing and sharing random numbers among operations and arithmetic logic units.

### BACKGROUND

### Field of the Invention

This invention relates generally to the field of artificial intelligence processors and more particularly to artificial intelligence accelerators.

### Description of the Related Art

Recent advancements in the field of artificial intelligence (AI) has created a demand for specialized hardware devices that can handle the computational tasks associated with AI processing. An example of a hardware device that can handle AI processing tasks more efficiently is an AI accelerator. The design and implementation of AI accelerators can present trade-offs between multiple desired characteristics of these devices.

In recent years, low precision computing (e.g., with a low bit-width) has provided an opportunity to make AI accelerators more efficient. Low precision computing demands less hardware resources, compared to high bit-width hardware. Various methods of rounding are used in some low precision operations (e.g., to convert a high precision number to low precision number). Some rounding methodologies rely on random or pseudorandom numbers (RNs/PRNs) to perform rounding operations and other arithmetic operations associated with processing of AI workloads. However, the hardware resources needed to generate RNs/PRNs can present their own hardware overhead and cost. For example, linear feedback shift registers (LFSRs) used to generate RNs/PRNs consume considerable chip area and power. Consequently, there is a need for AI accelerators that can perform low precision arithmetic, with reduced reliance on hardware resources needed to generate RNs/PRNs.

### SUMMARY

In one aspect of the invention a method of accelerating artificial intelligence processing is disclosed. The method includes: grouping operations of an AI workload in one or more groups at least partially based on number of operations in each group dependent on a random number value for performance of the operations; receiving a random number for each group; and performing the operations in each group based on the random number, wherein each operation in each operation group reuses the same random number.

In one embodiment, the random number for each group is preloaded in a memory of the accelerator.

In another embodiment, the method further includes generating the random number for each group.

In some embodiments, the random number for each group is chosen from a set of random numbers and receiving random number for each group further comprises cycling through the set of random numbers.

In one embodiment, the AI workload comprises training of a deep neural network and length of each group is above a minimum operation length, wherein the minimum operation length comprises the minimum number of operations above which reusing a random number for a group of operations yields convergence in the training of the deep neural network.

In some embodiments, the AI workload comprises training of a deep neural network and each group reuses the same random number for a duration shorter than a maximum operation time, wherein the maximum operation time comprises a time duration below which reusing random numbers yields convergence in the training of the deep neural network.

In another embodiment, the grouping of operations of the AI workload further includes: scanning the AI workload to determine which operations depend on a random number value for performance of the operations; and generating a schedule of reusing the random numbers between the groups.

In another embodiment, the AI workload comprises backpropagation.

In one embodiment, the operations comprise fixed- or floating-point operations.

In some embodiments, the operations comprise stochastic rounding.

In another aspect of the invention, an artificial intelligence accelerator is disclosed. The accelerator can include: one or more random number generators, in communication with one or more memory units, and configured to generate and store random numbers in the one or more memory units; a controller configured to: group operations of an AI workload in one or more groups at least partially based on number of operations in each group dependent on a random number value for performance of the operations; receive a random number for each group from the one or more memory units; and one or more arithmetic logic units (ALUs), configured to perform the operations in each group using the random number, wherein each operation in each operation group reuses the same random number.

In some embodiments, the controller is further configured to generate a signal commanding the one or more random number generators to generate and store random numbers in the one or more memory units.

In one embodiment, the ALU is further configured to cycle through a set of random numbers when performing operations in each group.

In some embodiments, the AI workload comprises training of a deep neural network and length of each group is above a minimum operation length, wherein the minimum operation length comprises the minimum number of operations above which reusing a random number for a group of operations yields convergence in the training of the deep neural network.

In one embodiment, the AI workload comprises training of a deep neural network and each group reuses the same random number for a duration shorter than a maximum operation time, wherein the maximum operation time comprises a time duration below which reusing random numbers yields convergence in the training of the deep neural network.

In some embodiments, the accelerator further includes a look-ahead-module configured to scan the AI workload to determine which operations depend on a random number value; and the controller is further configured to generate a schedule of reusing random numbers between the groups.

In one embodiment, the AI workload comprises backpropagation.

In another embodiment, the operations comprise fixed- or floating-point operations.

In one embodiment, the operations comprise stochastic rounding.

In some embodiments, the controller is further configured to randomly reuse the random numbers among the groups.

In another aspect of the invention, a method of accelerating artificial intelligence processing is disclosed. The method includes: grouping arithmetic logic units (ALUs) at least partially based on whether an ALU is to be used for performing stochastic rounding; receiving a random number for each group; and sharing the random number between the ALUs of a group, wherein the ALUs in each group share the random number for performing AI operations, wherein the AI operations comprise stochastic rounding.

In some embodiments, the random number for each group is preloaded in a memory of the accelerator.

In one embodiment, the method further includes generating the random number for each group.

In another embodiment, the random number for each group is chosen from a set of random numbers and receiving a random number for each group comprises cycling through the set of random numbers.

In some embodiments, the sharing is based on a random assignment schedule.

In one embodiment, the sharing is based on a dynamically-determined schedule or a predetermined schedule.

In one embodiment, the method further includes generating a new random number for each group after a period of time longer than a predetermined duration of time, or after processing a predetermined number of operations.

### BRIEF DESCRIPTION OF THE DRAWINGS

These drawings and the associated description herein are provided to illustrate specific embodiments of the invention and are not intended to be limiting.

FIG. 1 illustrates an example architecture of an AI accelerator according to an embodiment.

FIG. 2 illustrates a chain of AI operations 24 which are performed using one or more random numbers according to an embodiment.

FIG. 3 illustrates a diagram of reusing RNs/PRNs via alternating between a set of RNs/PRNs values for an AI workload.

FIG. 4 illustrates an AI accelerator, where each random number generator is configured to provide random numbers to two rows of arithmetic logic units.

FIG. 5 illustrates an random number assignment diagram in an AI accelerator according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Artificial intelligence (AI) techniques have recently been used to accomplish many tasks. Some AI algorithms work by initializing a model with random weights and variables and calculating an output. The model and its associated weights and variables are updated using a technique known as training. Known input/output sets are used to adjust the model variables and weights, so the model can be applied to inputs with unknown outputs. Training involves many computational techniques to minimize error and optimize variables. An example of a training method used to train neural network models is backpropagation, which is often used in training deep neural networks. Backpropagation works by calculating an error at the output and iteratively computing gradients for layers of the network backwards throughout the layers of the network. An example of a backpropagation technique used is stochastic gradient descent (SGD).

Additionally, hardware can be optimized to perform AI operations more efficiently. Hardware designed with the nature of AI processing tasks in mind can achieve efficiencies that may not be available when general purpose hardware is used to perform AI processing tasks. Hardware assigned to perform AI processing tasks can also or additionally be optimized using software. An AI accelerator implemented in hardware, software or both is an example of an AI processing system which can handle AI processing tasks more efficiently.

Some artificial intelligence (AI) processing can be carried out with numbers processed or handled in lower precision to increase performance and efficiency of the hardware tasked with performing the AI processing. Generally, a computer architecture designed to handle higher precision numbers requires more resources in hardware to implement high precision arithmetic needed for handling high precision numbers. AI workloads in some portions can be handled with low precision numbers and consequently, hardware tasked with handling AI workloads can be designed more efficient by handling some arithmetic operations in low precision hardware. Low precision hardware also demands less resources and circuitry and can consequently be less costly to manufacture compared to high precision hardware.

Rounding techniques can be used in AI processing and in low precision AI hardware to allow low precision numbers and arithmetic to substitute for high precision numbers and arithmetic. Some typical rounding techniques that may be used include rounding to nearest integer, truncation, round-down, round-up, and others. Common rounding techniques can introduce problems if used indiscriminately in the context of AI processing workloads, for example during training operations. For example, low precision arithmetic (e.g., when rounding down is used) in large add-chains and/or when adding a gradient descent update to a neural network weights, low precision arithmetic can yield a zero output, when a non-zero output is expected or desired. A simple example, is adding the number 0.3 a thousand times should yield 300, while a low precision hardware may round down each 0.3 to 0 and add Os, 1000 times leading to a zero output.

To address the issues introduced by crude rounding, stochastic rounding can be used, where a probability function defines the rounding. One definition of stochastic rounding is outlined by Eq. 1.

$$Round ( x ) = \{ \begin{matrix}⌊ x ⌋ & with probability 1 - ( x - ⌊ x ⌋ ) \\ ⌊ x ⌋ + 1 & with probability x - ⌊ x ⌋\end{matrix} \qquad Eq . 1$$

When applied over a multitude of arithmetic operations, stochastic rounding can produce better outputs compared to the outputs generated by crude or fixed rounding methods. For instance, a probabilistic rounding in some individual operations in a chain of numerical operations can introduce rounding errors (e.g., rounding 0.85 to 0, when rounding to 1 may be desirable), but over the full chain of the numerical operations, the probabilistic rounding can produce more accurate and desirable outputs than if other methods of rounding were to be used.

Stochastic rounding can be used in both fixed- and floating-point hardware. AI hardware that implements stochastic rounding (e.g., hardware that uses stochastic rounding to carry out low precision arithmetic) may use random or pseudorandom number generators (PRNG) to implement the probability function of the stochastic rounding. Linear Feedback Shift Registers (LFSRs) are among the common components used to generate random or pseudorandom numbers for stochastic rounding in AI workloads.

In some implementations of stochastic rounding in fixed- or floating-point hardware, where an M-bit number is to be rounded, an N-bit random number (RN) or pseudorandom (PRN) number is generated. The M-bit number, in whole or in part, is added to, subtracted from, multiplied with or divided by the N-bit RN/PRN. The resulting value is then rounded, by some rounding method such as nearest-integer-rounding, round-up, round-down, etc. In some implementations, one or more instances of stochastic rounding may be applied. In floating-point stochastic rounding, the M-bit number is usually a portion of an intermediate value of the mantissa. This is because in some cases, the least significant bits in mantissa are less likely to contribute to the end-result rounding and can be disregarded to make the hardware more efficient (by dropping some bits from mantissa and performing numerical operations with fewer number of bits and consequently less resources in hardware and time).

In conventional stochastic rounding as used in training neural networks, deep learning and other AI operations, each instance of stochastic rounding is provided with a locally-placed RN/PRN generator, usually embedded in arithmetic logic units (ALUs) or floating-point units (FPUs). The RN/PRN generators provide each instance of stochastic rounding with a fresh RN or PRN to carry out the stochastic rounding operation. Generating a fresh RN/PRN for every instance of stochastic rounding operation can substantially increase the hardware, time and power cost associated with AI accelerators that implement stochastic rounding.

By contrast, the described embodiments disclose techniques that enable an AI accelerator to reuse and/or share RNs/PRNs, between the arithmetic operations and/or ALUs and FPUs that perform stochastic rounding, thereby saving on hardware resources and enabling more efficient computing. As an example, arithmetic involving short accumulation chains are more sensitive to reusing RNs/PRNs. For short accumulation chains reusing RNs/PRNs for too long can turn the stochastic rounding into a form of deterministic rounding, which can introduce a systematic bias. In other words, reusing an RN/PRN for short accumulation chains can be equivalent to randomly-initialized deterministic rounding which can introduce systematic bias and overall lead to undesirable rounding errors. In general, large errors introduced by rounding can compromise the accuracy of neural network and/or lead to lack of convergence when performing training. On the other hand, reusing RNs/PRNs for accumulation chains of larger than a threshold can be effective without introducing detrimental systematic bias.

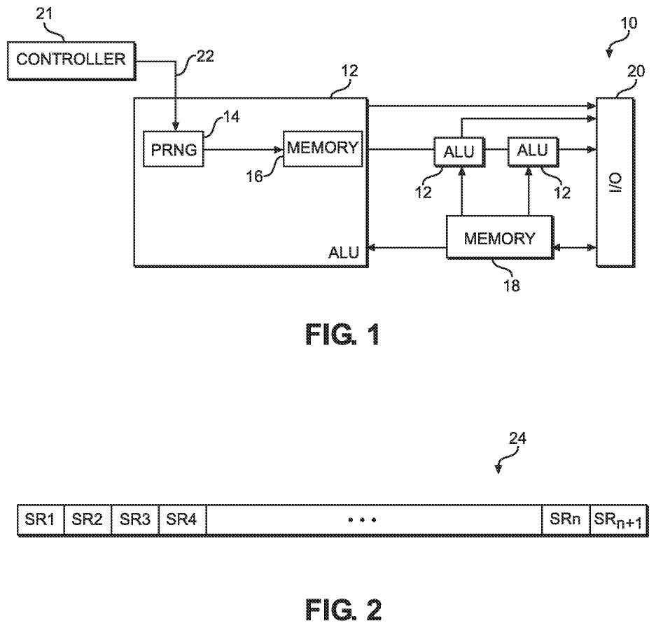

FIG. 1 illustrates an example architecture of an AI accelerator 10 according to an embodiment. The Accelerator 10 can include one or more ALUs 12, one or more of which can include PRNG 14. The PRNGs 14 can be random or pseudorandom number generators configured to provide random numbers or pseudorandom numbers for the purposes of performing stochastic rounding during AI operations. The ALUs 12 are in communication with a memory hierarchy 18, such as a memory array. The ALUs 12 and memory 18 can be in communication with components outside the accelerator 10 via an input/output (I/O) interface 20.

One or more PRNGs 14 in ALUs 12 can be in communication with a memory unit 16 for the purposes of saving and reusing RNs/PRNs and/or sharing RNs/PRNs with other ALUs 12. A controller 21 can generate a control signal 22, which can command the PRNG 14 in ALU 12 to generate and store an RN/PRN in memory 16. The ALU 12 can reuse the RN/PRN stored in memory 16 in one or more operation chains, or a portion of an AI operation chain. Additionally, the RN/PRN values stored in memory 16 can be used in other ALUs 12 of the accelerator 10.

The components shown are an example implementation of the embodiments described herein. Other architectures can also implement the described embodiments. For example, the PRNG 14 can be a component of a floating point unit (FPU). Some components may be made in hardware, software or a combination of the two. Whether a component is external or internal in relation to other components can be changed depending on the implementation and design considerations of the accelerator 10, such as chip area, manufacturing processes available, whether or not cost-saving measures can be realized by using pre-fabricated components and other considerations.

Stale Entropy

In some embodiments, the ALU 12 can be configured to reuse a previously-generated RN/PRN value among operations whose collective size is larger than a threshold. FIG. 2 illustrates a chain of AI operations 24 which are performed using one or more RNs/PRNs. Examples of such operations include instances where stochastic rounding is to be performed, such as stochastic rounding of least significant bit (LSB) and truncation of excess most significant bits (MSB). Several performance advantages can be realized by reusing the RNs/PRNs generated in PRNGs 14. For example, slower speed PRNGs 14 can be used when ALU 12 does not have to generate a fresh RN/PRN for every operation of the chain 24. Additionally, when RN/PRN are reused, the PRNGs 14 and associated circuitry need not run for every operation of the AI operations chain 24, thereby a power-saving advantage can be realized. Reusing the RN/PRN values in an ALU 12 can be termed “stale entropy”.

The AI operations chain 24 can represent a portion of an AI workload, or an entire AI workload. The ALU 12 can be configured to maintain and reuse the same value of RN/PRN for the entirety of an AI workload or for a portion of it. In one embodiment, a minimum operation length can be determined. The minimum operation length can be defined as the minimum number of operations in an AI operation chain, above which stale entropy and/or shared entropy (as will be described herein) can be effectively used. Consequently, an ALU 12 can be configured to reuse an RN/PRN value for AI operation chains 24 of length above the minimum operation length. In some embodiments, the ALU 12 can be configured to perform AI operation chains of arbitrary lengths with the same RN/PRN values, so long as the lengths of operation chains for which the RN/PRN values are reused do not drop below the minimum operation length.

Fixed or Preloaded RN/PRN

In some applications, one or more values of RN/PRN can be fixed or preloaded into the accelerator 10. Memory 16 can be a read-only memory (ROM), SRAM array or registers, preloaded with one or more RN/PRN values or a schedule of RN/PRN values, which the accelerator 10 can use when processing incoming AI workloads. In an embodiment, where RN/PRN values are preloaded, the PRNGs 14 and associated circuitry can be skipped and the area associated with them can be freed up for other components or the accelerator 10 can be made in chip areas with smaller sizes.

An accelerator 10 preloaded with RN/PRN values can be helpful in several applications, where replicating the random numbers (or using identical random numbers) as used in previous AI workloads can provide advantages (e.g., studying and improving performance of AI models, such as deep learning.

In another embodiment, reusing RNs/PRNs can be time dependent instead of or in addition to depending on the length of operations. For example, the ALU 12 can be configured to reuse an RN/PRN for an interval of time shorter than a maximum operation time. Maximum operation time for an AI workload can be defined as the time period during the performance of a chain of AI operations, below which stale entropy and/or shared entropy (as will be described herein) can be used effectively. As input units arrive at an ALU 12, the ALU 12 processes those input units reusing the same RN/PRN value until the maximum operation time is reached. The ALU 12 can then generate a fresh random number for the subsequent time interval and so forth.

In some embodiments, the conditions of an upcoming AI workload can be scanned and a schedule of reusing RNs/PRNs can be generated. For example, the upcoming AI workload can be grouped based on how many operations in the group depend on RNs/PRNs for their performance. Each group can be of a length (number of operations needing RNs/PRNs) above the minimum operation length. The ALU 12 can be configured to generate and use a fresh RN/PRN for each group.

In some embodiments, the ALU 12 can be configured to reuse the RNs/PRNs by alternating between a plurality of RNs/PRNs according to a predefined or dynamically defined schedule. For example, the PRNG 14 can be configured to generate and store in memory 16 a plurality of RNs/PRNs. The ALU 12 can be configured to process AI operations by alternating between the plurality of RNs/PRNs. In another implementation, the PRNG 14 and associated circuitry may be skipped and memory 16 may be preloaded with RNs/PRNs, which the ALU 12 cycles through when performing AI operations requiring stochastic rounding.

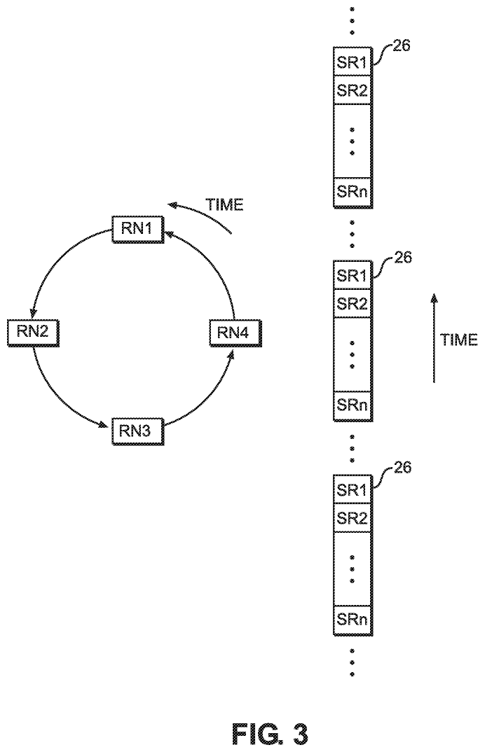

FIG. 3 illustrates a diagram of reusing RNs/PRNs via alternating between a set of RNs/PRNs values for an AI workload. The AI workload can include groups 26 of AI operations where each group includes a number of operations above the minimum operation length. For illustration purposes four random numbers, RN1, RN2, RN3 and RN4 are generated or preloaded (depending on the implementation). More or fewer RNs/PRNs can also be used. Each group 26 is processed using one of the random numbers, RN1-RN4. The ALU 12 can cycle through the plurality of the random numbers RN1-RN4, as it processes groups 26 of the AI workload, using RN1 for processing the first group 26, using RN2 for processing the second group 26, using RN3 for processing the third group 26, using RN4 for processing the forth group 26, and using RN1 for the fifth group 26 and so forth.

The minimum operation length and/or maximum operation time can be determined based on a variety of factors and techniques, including for example, based on the computational throughput of the accelerator and/or ALUs/FPUs, the number of ALUs/FPUs, the numerical instability tolerance of the underlying AI model, workload, number of operations, accumulation chain's length, and other factors. In some embodiments, the minimum operation length and/or the maximum operation time can be determined empirically.

In some embodiments, the reusing of RNs/PRNs can dynamically adapt to the conditions of the AI workload. For example, an estimate of the future incoming input loads can be made based on history of past input loads. In another embodiment, a look-ahead module (LAM) can scan through the incoming input loads before they are to be processed and convey the incoming workload conditions to controller 21 for modifying and/or generating an adaptive schedule of reusing RNs/PRNs.

Shared Entropy

In addition to, or instead of, reusing random numbers, RNs/PRNs can be shared across two or more ALUs 12 to further reduce the number of PRNGs 14, their associated circuitry and general power and area associated with generating them. The term “shared entropy” can refer to the technique of sharing RNs/PRNs across multiple ALUs.

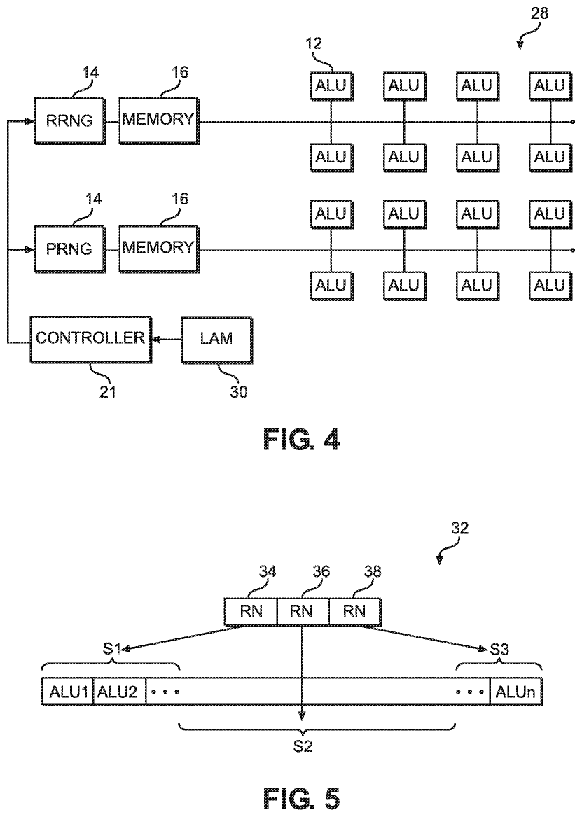

FIG. 4 illustrates an AI accelerator 28, where each PRNG 14 is configured to provide RNs/PRNs to two rows of ALUs 12. Other arrangements are possible too, where a single PRNG 14 provides random numbers to fewer or more rows of ALUs. The AI accelerator 28 is an example of a predefined shared-entropy, where the pattern of sharing random numbers across ALUs 12 is predefined in hardware. In other embodiments, shared entropy can be dynamically determined and/or defined in software or a combination of hardware and software. For example, one or more PRNGs 14 can be configured to provide RNs/PRNs to multiple ALUs 12 in a dynamically-determined pattern. A look-ahead-module (LAM) 30 can scan the conditions of upcoming AI input data and determine which ALUs will need RNs/PRNs to process the upcoming data. The controller 21 can then configure one or more PRNGs 14 to provide RN/PRN to those ALUs 12.

In one embodiment, a set of PRNGs 14 can provide RNs/PRNs to two or more ALUs based on a random assignment schedule. In another implementation, the assignment of PRNGs to ALUs can be based on a weighted random distribution to favor refreshing the RNs/PRNs for some ALUs 12 more than others (e.g., when an ALU 12 is used more frequently in AI operations having more sensitivity to rounding errors).

FIG. 5 illustrates an assignment diagram 32 of PRNGs in an AI accelerator having n ALUs (ALU1, ALU2, ALUn). Three random numbers, RN 34, RN 36 and RN 38 are shown. Fewer or more random numbers are also possible. The random numbers RN 34, 36 and 38 can be generated from three PRNGs 14, each generating one random number, two PRNGs 14, where one generates two random numbers and the other generates one, or a single PRNG 14 generating three random numbers. Alternatively, the random numbers can be preloaded as described earlier, without the need for PRNGs 14. The n ALUs can be grouped into three groups (equal to the number of random numbers used). Groups S1, S2 and S3 are shown. However, fewer or more groups are also possible if the random numbers shared among the ALUs of a group are swapped in each time step or some other predetermined interval of time.

In another embodiment, instances of stochastic rounding among the ALU1-ALUn can be determined and those ALUs performing stochastic rounding can be assigned a PRNG 14 and an associated RN/PRN. For example, in the assignment diagram 32, when there are instances of stochastic rounding in the AI operations of groups S1, S2 and S3, then RN 34 can be assigned to be shared among the ALUs of the group S1; RN 36 can be assigned to be shared among the ALUs of the group S2; and RN 38 can be assigned to the ALUs of the group S3, so each group can perform stochastic rounding operations associated with their AI operations. In another scenario, if only the ALUs of the groups S1 and S3 perform stochastic operations associated with their AI operations, RN 34 can be assigned to the ALUs of the group S1 and RN 38 can be assigned to the ALUs of the group S3, and the PRNG 14 associated with the RN 36 can be idle.

In one embodiment, the random numbers assigned to ALU groups S1-S3 can be refreshed after a duration of time longer than the maximum operation time. New random numbers can be generated after the ALUs of a group have performed a number of operations greater than a predetermined number (e.g., when a multiplier of the minimum operation length is reached). Additionally, the random numbers can be refreshed if the ALUs of a group are determined not to have operation chains of length above the minimum operation length.

The choice for the number of PRNGs and pattern of assignment of random numbers can be determined based on the type of workload that the AI accelerator is designed to handle, the number of ALUs, number and type of operations, the power and area constraints of the AI accelerator and other considerations.

AI accelerators performing AI processing tasks can take advantage of the disclosed systems and methods to increase their hardware and software efficiency of performing numerical computations associated with processing AI workloads. Examples of numerical computations, which can be performed efficiently with the described embodiments include: fixed- and floating-point addition, subtraction, multiplication, division, reciprocal, comparison, absolute value, negation, maximum, minimum, elementary functions, square root, logarithm, exponentiation, sine, cosine, tangent, arctangent, format conversions, and multiply-and-accumulate (MAC) and other operations. Examples of AI processing tasks can include machine learning, neural network processing, deep learning, training of AI models (e.g., deep neural network training) and others.

What is claimed is:

1. A method of accelerating artificial intelligence processing, comprising:
grouping operations of an AI workload in one or more groups at least partially based on number of operations in each group dependent on a random number value for performance of the operations;
receiving a random number for each group; and
performing the operations in each group based on the random number, wherein each operation in each operation group reuses the same random number.

2. The method of claim 1, wherein the random number for each group is preloaded in a memory of the accelerator.

3. The method of claim 1, further comprising generating the random number for each group.

4. The method of claim 1, wherein the random number for each group is chosen from a set of random numbers and receiving random number for each group further comprises cycling through the set of random numbers.

5. The method of claim 1, wherein the AI workload comprises training of a deep neural network and length of each group is above a minimum operation length, wherein the minimum operation length comprises the minimum number of operations above which reusing a random number for a group of operations yields convergence in the training of the deep neural network.

6. The method of claim 1, wherein the AI workload comprises training of a deep neural network and each group reuses the same random number for a duration shorter than a maximum operation time, wherein the maximum operation time comprises a time duration below which reusing random numbers yields convergence in the training of the deep neural network.

7. The method of claim 1, wherein the grouping of operations of the AI workload further comprises:
scanning the AI workload to determine which operations depend on a random number value for performance of the operations; and
generating a schedule of reusing the random numbers between the groups.

8. The method of claim 1, wherein the AI workload comprises backpropagation.

9. The method of claim 1, wherein the operations comprise fixed- or floating-point operations.

10. The method of claim 1, wherein the operations comprise stochastic rounding.

11. An artificial intelligence accelerator, comprising:
one or more random number generators, in communication with one or more memory units, and configured to generate and store random numbers in the one or more memory units;
a controller configured to:
group operations of an AI workload in one or more groups at least partially based on number of operations in each group dependent on a random number value for performance of the operations;
receive a random number for each group from the one or more memory units; and
one or more arithmetic logic units (ALUs), configured to perform the operations in each group using the random number, wherein each operation in each operation group reuses the same random number.

12. The accelerator of claim 11, wherein the controller is further configured to generate a signal commanding the one or more random number generators to generate and store random numbers in the one or more memory units.

13. The accelerator of claim 11, wherein the ALU is further configured to cycle through a set of random numbers when performing operations in each group.

14. The accelerator of claim 11, wherein the AI workload comprises training of a deep neural network and length of each group is above a minimum operation length, wherein the minimum operation length comprises the minimum number of operations above which reusing a random number for a group of operations yields convergence in the training of the deep neural network.

15. The accelerator of claim 11, wherein the AI workload comprises training of a deep neural network and each group reuses the same random number for a duration shorter than a maximum operation time, wherein the maximum operation time comprises a time duration below which reusing random numbers yields convergence in the training of the deep neural network.

16. The accelerator of claim 11 further comprising a look-ahead-module configured to scan the AI workload to determine which operations depend on a random number value; and the controller is further configured to generate a schedule of reusing random numbers between the groups.

17. The accelerator of claim 11, wherein the AI workload comprises backpropagation.

18. The accelerator of claim 11, wherein the operations comprise fixed- or floating-point operations.

19. The accelerator of claim 11, wherein the operations comprise stochastic rounding.

20. The accelerator of claim 11, wherein the controller is further configured to randomly reuse the random numbers among the groups.

21. A method of accelerating artificial intelligence processing, comprising:
grouping arithmetic logic units (ALUs) at least partially based on whether an ALU is to be used for performing stochastic rounding;
receiving a random number for each group; and
sharing the random number between the ALUs of a group, wherein the ALUs in each group share the random number for performing AI operations, wherein the AI operations comprise stochastic rounding.

22. The method of claim 21, wherein the random number for each group is preloaded in a memory of the accelerator.

23. The method of claim 21 further comprising generating the random number for each group.

24. The method of claim 21, wherein the random number for each group is chosen from a set of random numbers and receiving a random number for each group comprises cycling through the set of random numbers.

25. The method of claim 21, wherein the sharing is based on a random assignment schedule.

26. The method of claim 21, wherein the sharing is based on a dynamically-determined schedule or a predetermined schedule.

27. The method of claim 21, further comprising generating a new random number for each group after a period of time longer than a predetermined duration of time, or after processing a predetermined number of operations.
